(19) United States
(12) Patent Application Publication
(10) Pub. No.: US 2010/0013771 A1
(43) Pub. Date: Jan. 21, 2010

(54) MOUSE HAVING SHAKE-ELIMINATION FUNCTION WHEN LEAVING WORKING PLANE

(76) Inventor: Kuo-Shu Cheng, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/400,949

(22) Filed: Mar. 10, 2009

(30) Foreign Application Priority Data
Jul. 18, 2008 (CN) 200810029585.4

(51) Int. Cl. G09G 5/08

(52) U.S. Cl. 345/166

(57) ABSTRACT

A mouse having a shake-elimination function when leaving a working plane is provided. A light sensing unit detects a light emitted by a light emitting unit toward a working plane or a column shaped member, and outputs a detection signal. A microprocessor determines whether the mouse is apart from the working plane according to the detection signal. When it is determined that the mouse is positioned apart from the working plane, the microprocessor clears the displacement amount obtained from the communication interface of the optical displacement sensor, and meanwhile the microprocessor inform the computer that the mouse is apart from the working plane. In such a way, when the user lifts the mouse up from the working plane, the displacement signal outputted from the optical displacement sensor won't cause the cursor shake.

### BACKGROUND OF THE INVENTION

1. Field of the Invention

The present invention relates generally to a mouse. When a user takes the mouse off the working plane, the cursor displayed on the computer display is shake-free. The present invention particularly relates to a mouse having a shake-elimination function when leaving a working plane.

2. The Prior Arts

Currently, optical displacement sensors are widely employed in mouse functions. Many conventional techniques of optical displacement sensors have involved algorithms for locking the cursor, when the mouse is lifted up from a working plane or operated on an unqualified working plane. For example, Taiwanese Patent No. I291123 and U.S. Pat. No. 6,433,780 disclose optical pointing apparatuses and control methods thereof. However, these two patents provide no solution to eliminate the shake of the cursor when the mouse is lifted up from a working plane or operated on an unqualified working plane. Taiwanese Patent No. I287200 discloses a safe control apparatus of optical mouse and a method thereof. Although Taiwanese Patent No. I287200 teaches to turn off the light source of the optical mouse, the patent concerns to safety factors, rather than to eliminate the shake of the cursor.

However, the accuracy requirement of mouse motion tracks must be satisfied. The algorithm must be correspondingly modified in order to lock the cursor when the mouse is lifted up from the working plane, as disclosed by Taiwanese Patent No. I291123. As such, current optical mouse using optical displacement sensors should be further improved for eliminating the shake of the cursor when the mouse is lifted up from the working plane.

FIG. 1 illustrates a typical conventional optical mouse. Referring to FIG. 1, the optical mouse employs an optical displacement sensor A for sensing the displacement of the mouse. As shown in FIG. 1, a displacement sensing light emitting unit C projects a light to the working plane 4. The light is then scattered to the optical displacement sensor A. Correspondingly, a displacement amount of the mouse is then outputted via a serial interface to a microprocessor B which is connected to a computer communication interface Al. The microprocessor then transfers data of the displacement amount to the computer D. However, when the user intentionally or involuntarily lifts up the mouse, there would be also a corresponding displacement amount outputted from the optical displacement sensor A, thus generating the shake of the computer cursor.

### SUMMARY OF THE INVENTION

A primary objective of the present invention is to provide an optical mouse having a shake-elimination function when leaving a working plane. When a user lifts the optical mouse up from the working plane, the cursor displayed on the computer display is shake-free.

For achieving the object of eliminating the cursor shake when the mouse is lifted up from the working plane, the present invention provides several approaches, according to which when it is detected that the mouse is lifted up by the user from the working plane, the output of the displacement amount of the optical displacement sensor is cleared. The several approaches are discussed below, respectively.

The first approach is to employ a light emitting unit and an optical sensing unit to detect reflectivity characteristics of a movable means. Referring to FIG. 2, it is a structural diagram illustrating a mouse positioned on a working plane. A column shaped member is assembled through an opening of a bottom cover of the mouse. When the mouse is positioned on the working plane, a bottom surface of the column shaped member is in contact with the working plane, and a top surface of the column shaped member is in contact with a surface of a light isolation plate of a light emitting/sensing module. The light emitting/sensing module includes a light emitting unit, a light sensing unit, and the light isolation plate. In this condition, the light sensing unit does not sense any light, and therefore it can be learn that the mouse is positioned on the working plane.

Referring to FIG. 3, it is a structural diagram illustrating that the mouse is lifted up from the working plane. As shown in FIG. 3, a column shaped member is assembled through the opening of the bottom cover of the mouse and is configured projecting out from a plane defined by foot pads of the mouse for a specific distance. The specific distance is equal to a distance from a top surface of the column shaped member to a surface of the light emitting/sensing module. The light emitting unit projects the light onto the top surface of the column shaped member, and the light is then reflected to the light sensing unit. In this case, the microprocessor determines that the mouse is apart from the working plane according to the sensed optical signal. The microprocessor retrieves data of the motion of the mouse from the optical displacement sensor, and clears the data. Meanwhile, the microprocessor outputs information to the computer to inform that the mouse is apart from the working plane. In such a way, when the user lifts the mouse up from the working plane, the displacement signal outputted from the optical displacement sensor won't cause the cursor shake.

Correspondingly, when the light sensing unit fails to the sense the light, it means the column shaped member is not positioned on the light path between the light emitting unit and the light sensing unit. Detecting the light and failing to detect the light correspond to statuses of the mouse positioning on the working plane and leaving apart from the working plane, respectively. The correspondence therebetween can be alternatively varied.

The second approach is to employ a movable means to cut off the light path between the light emitting unit and the light sensing unit. Referring to FIG. 4, it is a structural diagram illustrating a mouse positioned on a working plane. A column shaped member is assembled through an opening of a bottom cover of the mouse. When the mouse is positioned on the working plane, a bottom surface of the column shaped member is in contact with the working plane. Meanwhile, a flat rectangular prism configured at an upper side of the column shaped member cuts off the light path between the light emitting unit and the light sensing unit. In this case, the light sensing unit fails to sense any light, and therefore it can be learnt that the mouse is positioned on the working plane. Referring to FIG. 5, it is a structural diagram illustrating that the mouse is lifted up from the working plane. As shown in FIG. 5, a column shaped member is assembled through the opening of the bottom cover of the mouse and is configured projecting out from a plane defined by foot pads of the mouse for a specific distance. The specific distance is equal to a vertical distance that the flat rectangular prism does not cut off the light path between the light emitting unit and the light sensing unit. In this case, the microprocessor determines that the mouse is apart from the working plane according to the sensed optical signal. The microprocessor retrieves data of the motion of the mouse from the optical displacement sensor, and thus clears the data. Meanwhile, the microprocessor outputs information to the computer to inform that the mouse is apart from the working plane. In such a way, when the user lifts the mouse up from the working plane, the displacement signal outputted from the optical displacement sensor won't cause the cursor shake.

Correspondingly, a further modified application is employing two light sensing units (i.e., also known as a dual phototransistor molded in a package receiver often used in optical mice or ball mice). The microprocessor determines different heights where the mouse and the working plane are positioned, and the direction of the mouse moving relative to the working plane, according to sensed optical signals. The microprocessor then clears the data of the motion of the mouse in accordance with different settings with respect to different heights.

According to another modified application employing such a dual phototransistor receiver, when the mouse is positioned on the working plane, there is only one light sensing unit senses the light. When the mouse is lifted up from the working plane, none of the light sensing units sense the light. Further, when the mouse is lifted up from the working plane and turned over upside down, both of the light sensing units sense the light. It should be noted that if desired, alternative application (i.e., none or both of the two light sensing units sense the light) can be conveniently selected and realized.

The third approach is to utilize the reflectivity characteristics of the light emitting unit and the light sensing unit regarding the working plane. Referring to FIG. 6, it is a structural diagram illustrating a mouse positioned on a working plane. Referring to FIG. 6, the light emitting unit, the light sensing unit and the light isolation plate are positioned at where the bottom cover of the mouse contacts the working plane, or where pads under the bottom cover of the mouse contact the working plane. The light emitting unit and the light sensing unit each is configured with a hole at the light path therebetween so as to allow the light passing therethrough. The light isolation plate is positioned between the light emitting unit and the light sensing unit. The light isolation plate can be configured integrally with the bottom cover or as an independent element. In other embodiments, it is also applicable that only one of the light emitting unit and the light sensing unit is positioned at where the pads under the bottom cover of the mouse contacts the working plane. Alternatively a module including the light emitting unit, the light sensing unit, and the light isolation plate can be employed. When the mouse is positioned on the working plane, the light isolation plate blocks the light emitted from the light emitting unit, and therefore the light sensing unit fails to sense a reflected light. As such, it can be learnt that the mouse is positioned on the working plane.

Referring to FIG. 6A, it is a structural diagram illustrating that the mouse is lifted up from the working plane. As shown in FIG. 7, when the mouse is lifted up from the working plane, the light emitting unit projects a light onto the surface of the working plane. The light is then reflected back to the light sensing unit. The microprocessor then determines that the mouse is positioned apart from the working plane according to the sensed optical signals. After retrieving the motion data of the mouse from the optical displacement sensor, the microprocessor clears the motion data of the mouse. Meanwhile, the microprocessor outputs information to the computer to inform that the mouse is apart from the working plane. In such a way, when the user lifts the mouse up from the working plane, the displacement signal outputted from the optical displacement sensor won't cause the cursor shake.

Correspondingly, a further modified application is to employ two light sensing units, for example, a dual phototransistor receiver often used in optical mice or ball mice. The microprocessor determines different heights where the mouse and the working plane are positioned, and the direction of the mouse moving relative to the working plane, according to sensed optical signals.

Further, the fourth approach is also to utilize the reflectivity characteristics of the light emitting unit and the light sensing unit regarding the working plane. Referring to FIG. 8, it is a structural diagram illustrating a mouse positioned on a working plane. The mouse includes a light emitting unit, two light sensing units, and a light isolation plate. The first light sensing unit is positioned at where the bottom cover of the mouse contacts the working plane, or where the pads under the bottom cover of the mouse contact the working plane. The light emitting unit and the second light sensing unit are positioned under the mouse and are not in contact with the working plane. The two light sensing units and the light emitting unit each is configured with a hole at the light path therebetween so as to allow the light passing therethrough. The opaque light isolation plate is positioned between the light emitting unit and the light sensing unit. When the mouse is positioned on the working plane, the light isolation plate blocks the light path of the light emitted from the light emitting unit to the first light sensing unit, and therefore the first light sensing unit fails to sense a reflected light. However, the light projected from the light emitting unit onto the working plane can be reflected or scattered to the second light sensing unit. As such, the microprocessor determines that the mouse is in positioned on the working plane according to the sensed optical signals by the second light sensing unit.

Referring to FIG. 9, it is a structural diagram illustrating that the mouse is lifted up from the working plane for a short distance. As shown in FIG. 9, the light emitting unit projects the light onto the working plane, so that the light can be reflected or scattered to both the first light sensing unit and the second light sensing unit. In this case, the microprocessor determines that the mouse is apart from the working plane for a short distance. Meanwhile, the microprocessor clears the motion data of the mouse, and outputs information to the computer to inform that the mouse is apart from the working plane for a short distance. In such a way, when the user lifts the mouse up from the working plane, the displacement signal outputted from the optical displacement sensor won't cause the cursor shake.

Referring to FIG. 10, it is a structural diagram illustrating that the mouse is lifted up from the working plane for a long distance. As shown in FIG. 10, in this case, the mouse is lifted up from the working plane for a long distance, and therefore there is substantially no light projected from the light emitting unit onto the working plane. Both of the first light sensing unit and the second light sensing unit correspondingly fail to sense any reflected light or scattered light from the working plane. Accordingly, the microprocessor determines that the mouse is lifted up from the working plane for a long distance according to the sensed optical signals.

For achieving a better flexibility, the present invention introduces the time delay technique, so that when the mouse is lifted up from or put down to the working plane, the cursor shakes because of the displacement signals outputted from the optical displacement sensor can be eliminated. In such a way, the mouse is improved to achieve a better identification accuracy, so as to allow the user to more preciously operate the mouse.

For achieving a better accuracy, the present invention sets a value of a current flowing through the light emitting unit and stores a sensing value obtained by the light sensing unit in the microprocessor. Therefore, the microprocessor is adapted for more accurately determining a distance from the mouse to the working plane according to the stored sensing value by setting the current value and the sensing value. Further, the present invention can employ an algorithm for automatically determining and regulating, thus storing the sensing values of the light sensing unit. In such a way, the present invention is adapted for avoiding cursor shakes caused by the output of the optical displacement sensor when the mouse is lifted up from or put down to the working plane, thus improving the identifying accuracy of the mouse, so as to allow the user to more preciously operate the mouse.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is schematic diagram illustrating a conventional mouse;

FIG. 2 is a schematic diagram illustrating an optical mouse working on a working plane according to a first embodiment of the present invention;

FIG. 2A is a schematic diagram illustrating the optical mouse being apart from the working plane according to the first embodiment of the present invention;

FIG. 2B is a schematic diagram illustrating the first embodiment including a spring member disposed over the column shaped member.

FIG. 3 is a schematic structural diagram illustrating an alternative variation of the optical mouse of the first embodiment;

FIG. 4 is a schematic diagram illustrating an optical mouse working on a working plane according to a second embodiment of the present invention;

FIG. 5 is a schematic diagram illustrating the optical mouse being apart from the working plane according to the second embodiment of the present invention;

FIG. 6 is a schematic diagram illustrating an optical mouse working on a working plane according to a third embodiment of the present invention;

FIG. 6A is a schematic diagram illustrating the optical mouse being apart from the working plane according to the third embodiment of the present invention;

FIG. 7 is a schematic diagram illustrating an optical mouse including two light sensing units working on the working plane according to the third embodiment of the present invention;

FIG. 7A is a schematic diagram illustrating an optical mouse including two light sensing units being apart from the working plane according to the third embodiment of the present invention;

FIG. 8 is a schematic diagram illustrating an optical mouse working on a working plane according to a fourth embodiment of the present invention;

FIG. 9 is a schematic diagram illustrating an optical mouse being apart from the working plane for a short distance according to a fifth embodiment of the present invention;

FIG. 10 is a schematic diagram illustrating the optical mouse being apart from the working plane for a long distance according to the fifth embodiment of the present invention;

FIG. 11 is a flow chart illustrating the shake elimination process conducted by a microprocessor; and

FIG. 12 is a flow chart illustrating the shake elimination process conducted by a switching circuit.

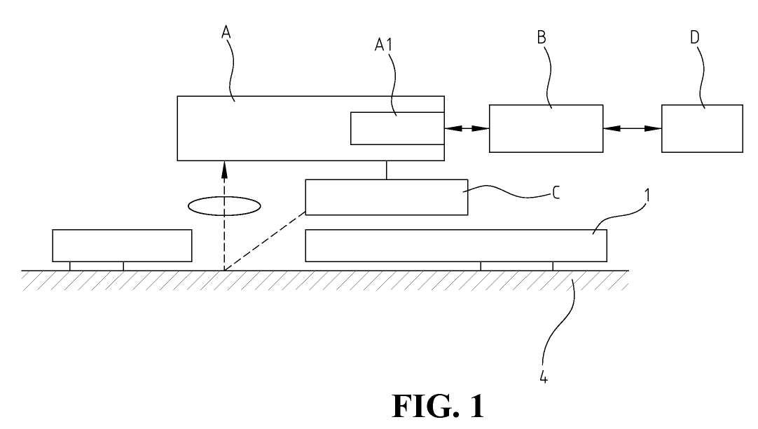

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

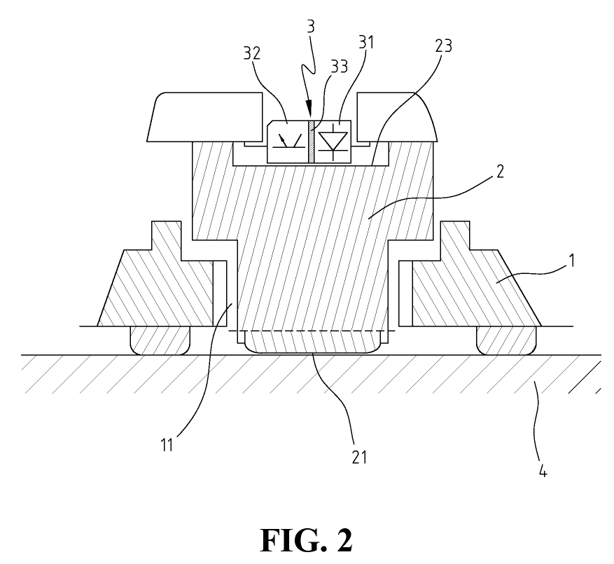

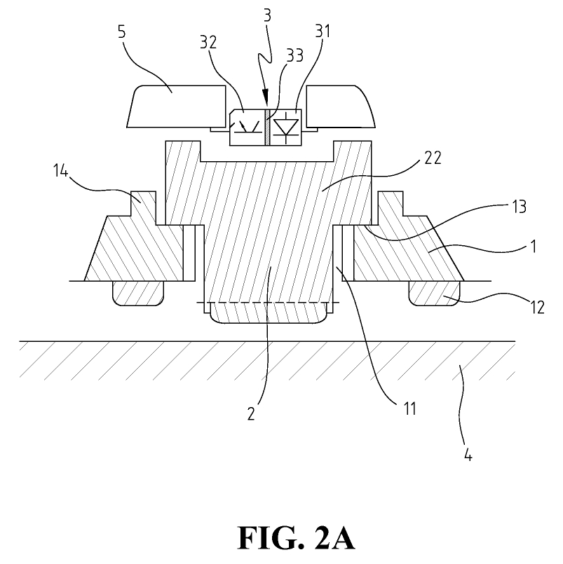

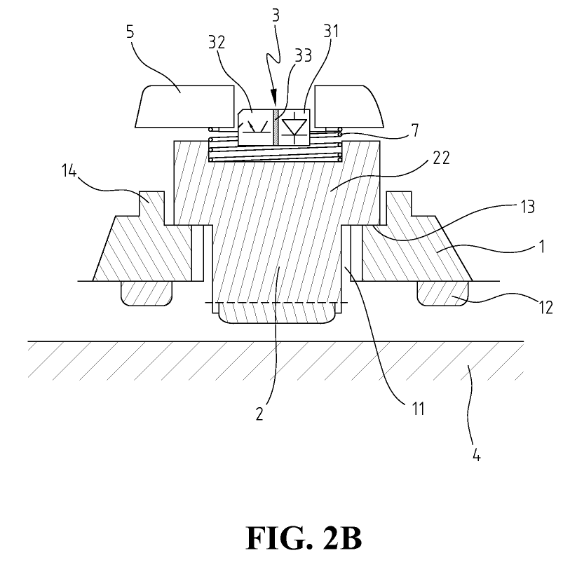

Generally, the first embodiment is to employ a light emitting unit and a light sensing unit for detecting a reflectivity characteristic of a movable means. As shown in FIGS. 2 and 2A, there are shown schematic diagrams illustrating the mouse positioned on the working plane and apart from the working plane, respectively.

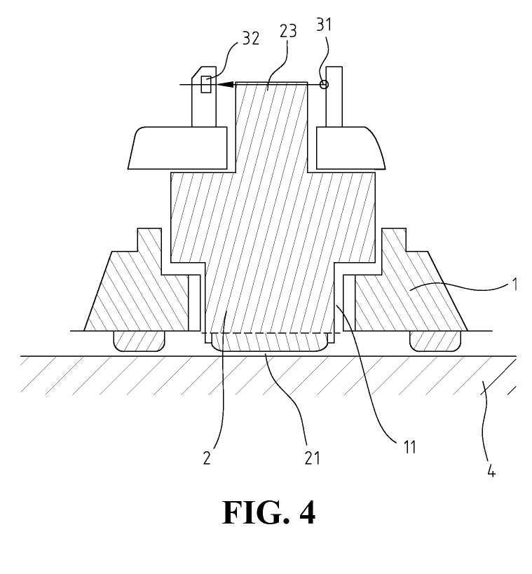

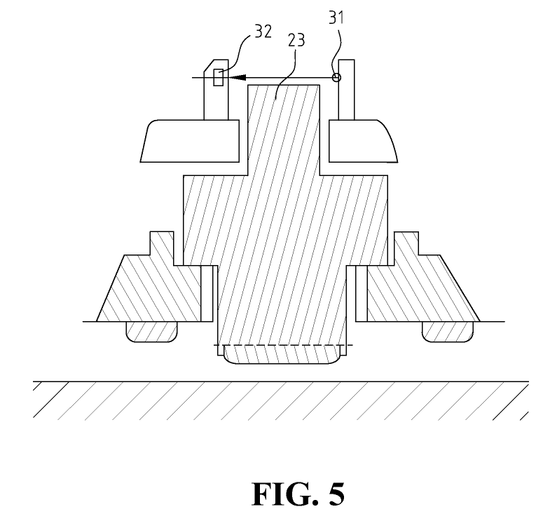

The second embodiment is to employ a movable means for cutting off the light path between the light emitting unit and the light sensing unit. As shown in FIGS. 4 and 5, there are shown schematic diagrams illustrating the mouse positioned on the working plane and apart from the working plane, respectively.

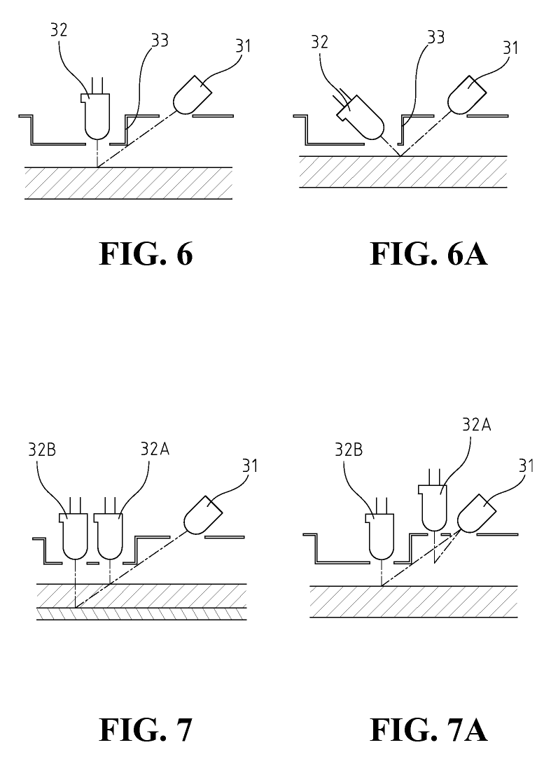

The third embodiment is to utilize the reflectivity characteristics of the light emitting unit and the light sensing unit regarding the working plane. As shown in FIG. 6 and 6A, there are shown schematic diagrams illustrating the mouse positioned on the working plane and apart from the working plane, respectively.

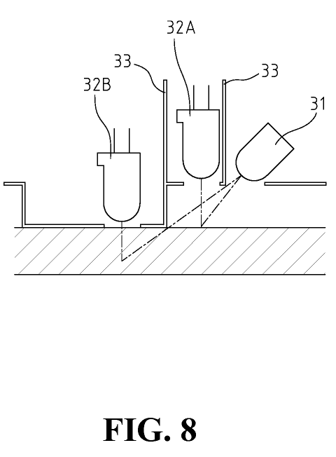

The fourth embodiment is also to utilize the reflectivity characteristics of the light emitting unit and the light sensing unit regarding the working plane. As shown in FIGS. 8, 9, and 10, there are shown schematic diagrams illustrating the mouse positioned on the working plane and apart from the working plane, respectively.

### The First Embodiment

Referring to FIG. 2, a column shaped member 2 is assembled through an opening 11 of a bottom cover 1 of the mouse. When the mouse is positioned upon a working plane 4, a bottom surface 21 of the column shaped member 2 is in contact with the working plane 4. At the same time, a top surface 23 of the column shaped member 2 is in contact with a surface of a light isolation plate of a light emitting/sensing module 3. The light emitting/sensing module 3 includes a light emitting unit 31, a light sensing unit 32, and the light isolation plate 33. In this condition, the light sensing unit does not sense any light, and therefore it can be learn that the mouse is positioned on the working plane 4.

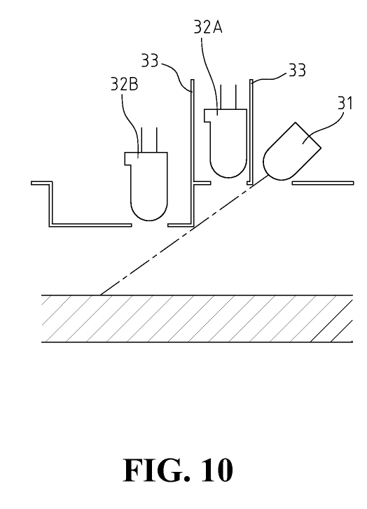

Referring to FIG. 2A, when the mouse is lifted up, the column shaped member 2 falls down as a free falling body, and moves downwardly relative to the body of the mouse. In such a way, the column shaped member 2 projects through the opening 11 of the bottom cover 1 of the mouse and out from a plane defined by foot pads 12 of the mouse. Correspondingly, when the mouse is positioned on the working plane 4, the foot pads 12 of the mouse are in contact with the working plane 4. As such, the column shaped member 2 projects out from the plane defined by the foot pads 12 of the mouse for a distance which is equal to a distance from the top surface 23 to the surface of the light emitting/sensing module 3. The light emitting unit 31 projects a light onto the top surface 23 of the column shaped member 2, and the light is then reflected to the light sensing unit 32. In this case, the microprocessor 31 (further referring to FIG. 10) determines that the mouse is apart from the working plane 4 according to the sensed optical signal. The microprocessor 51 retrieves data of the displacement of the mouse from an optical displacement sensor 52, and clears the data. Meanwhile, the microprocessor 51 outputs information to a computer 6 to inform that the mouse is apart from the working plane 4. In such a way, when the user lifts the mouse up from the working plane 4, the displacement signal outputted from the optical displacement sensor 52 won't cause the cursor shake.

Correspondingly, when the mouse is lifted up from the working plane 4, a protrusion portion 22 of the column shaped member 2 falls down and gets in contact with an upper surface 13 of the bottom cover 1 of the mouse, and is stopped thereby. In such a way, the protrusion portion 22 of the column shaped member 2 can be considered as equivalently movable between the bottom cover 1 and a circuit board 5.

According to an aspect of the current embodiment, a baffle wall 14 is provided for increasing the space between the protrusion portion 22 of the column shaped member 2 and opening 11 of the bottom cover 1 of the mouse, so as to prevent fine dirt clogged therebetween affecting the free falling movement of the column shaped member 2. The baffle wall 14 is disposed on the upper surface 13 of the bottom cover 1 of the mouse. The baffle wall 14 is positioned away from the protrusion portion 22 of the column shaped member 2 for a suitable distance, so as to increase the space between the protrusion portion 22 of the column shaped member 2 and opening 11 of the bottom cover 1 of the mouse.

Further, according to another aspect of the current embodiment, referring to FIG. 2B, a spring member 7 (or a suitable weight) is provided on the top surface 23 or the protrusion portion 22 of the column shaped member, for facilitating the column shaped member to moving downwardly when the mouse is lifted up from the working plane. Furthermore, the protrusion portion 22 of the column shaped member can be alternatively attached with mouse-use foot pads having a small friction coefficient. Therefore, the user is allowed to adjust the height, and the mouse can be more smoothly used. The height adjusting function discussed hereby means when the mouse is lifted to the specific height, the microprocessor retrieves data of the displacement of the mouse from the optical displacement sensor 52, and clears the data.

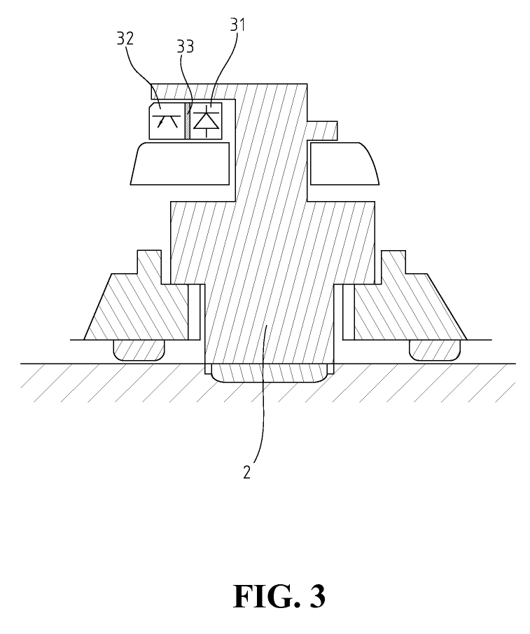

According to a further aspect of the current embodiment, the light emitting unit 31 and the light sensing unit 32 is disposed on the circuit board 5, as shown in FIG. 3. In this case, the light sensing unit 32 is turned over for 180° with respect to the configuration of FIG. 2, in which the light sensing signals are exchanged for representing the positions of the mouse (i.e., on the working plane or apart from the working plane). According to still a further aspect of the current embodiment, the light emitting unit 31 and the light sensing unit 32 can be turned over for 90° with respect to the configuration of FIG. 2, so that the light emitting unit 31 and the light sensing unit 32 are disposed substantially parallel with or perpendicular to the bottom cover 1 of the mouse. In such a way, the column shaped member 2 moves on the light path of the projected light and the reflected light of the light emitting unit 31 and the light sensing unit 32. The corresponding relationships of sensing and not sensing light to the mouse on the working plane and apart from the working plane can be arbitrarily exchanged. Furthermore, the current embodiment can be further modified by sensing the intensity of the light so as to identify a first height and a second height that the mouse apart from the working plane.

Moreover, the mouse can be further provided with a spring member. The spring member restraints the movement of the column shaped member when the mouse is turned over upside down, thus avoiding misjudging that the mouse as being positioned on the working plane when it is in fact turned over.

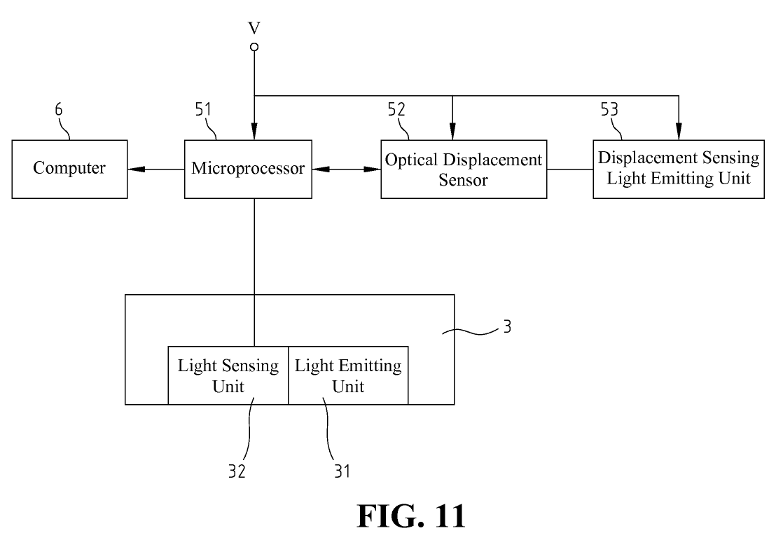

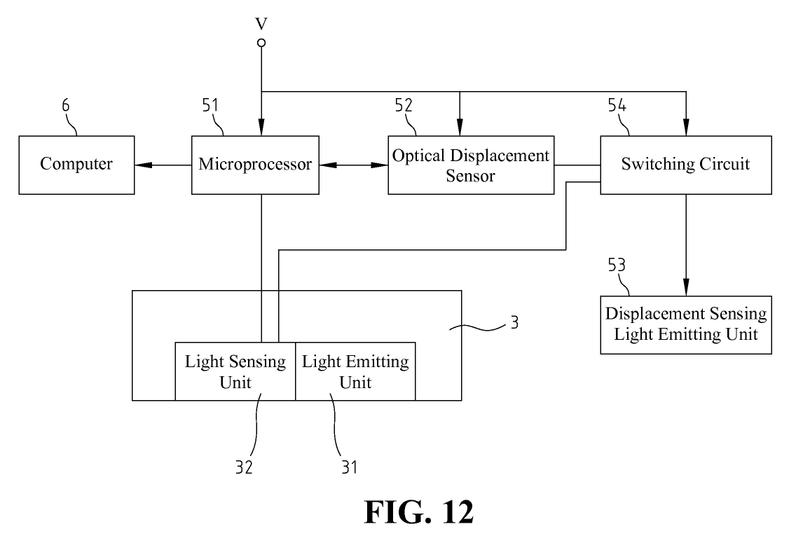

Further, for achieving the safe control and/or shake elimination function of the displacement sensing light emitting unit 53 of the optical mouse, a switching circuit 54 can be further serially coupled between a power supply and the displacement sensing light emitting unit 53, as shown in FIG. 11. Referring to FIG. 11, the microprocessor 51 retrieves the sensing signals from the light sensing unit 32, and determines whether the mouse is positioned apart from the working plane 4 or not, according to the retrieved sensing signals. When it is determined that the mouse is lifted up from the working plane 4, the microprocessor 51 controls the switching circuit 54 to turn off the power supply of the displacement sensing light emitting unit 53. Or otherwise, alternatively, the switching circuit 54 includes a power supply adapted for turning off the displacement sensing light emitting unit 53 according to the sensing signals used for determining whether the mouse is positioned apart from the working plane 4 or not.

### The Second Embodiment

The second embodiment is to employ a movable means to cut off the light path between the light emitting unit and the light sensing unit, as shown in FIG. 4. Referring to FIG. 4, it is a structural diagram illustrating a mouse positioned on a working plane. A column shaped member 2 is assembled through an opening 11 of a bottom cover 1 of the mouse, which is similar with the configuration of the first embodiment. The column shaped member 2 is also movable in a manner similar to that of the first embodiment. However, the column shaped member 2 in the second embodiment is used for cutting off the light path between the light emitting unit and the light sensing unit. The light emitting/sensing module 3 includes a light emitting unit 31 and a light sensing unit 32. A light path therebetween is constituted by a light projected from the light emitting unit 31 directly to the light sensing unit 32. When the mouse is positioned on the working plane 4, a bottom surface 21 of the column shaped member 2 is in contact with the working plane 4. Meanwhile, an upper portion 23 of the column shaped member 2 cuts off the light path of the light emitting/sensing module 3. In this case, the light sensing unit 32 fails to sense any light, and therefore it can be learnt that the mouse is positioned on the working plane 4.

Referring to FIG. 5, when the mouse is lifted up from the working plane 4, the column shaped member 2 moves downwardly. The upper portion 23 moves a distance which is equal to a distance that the column shaped member 2 moves. As such, the light emitting unit 31 can directly project the light onto the light sensing unit 32 without being cut off. Therefore, the microprocessor 51 determines that the mouse is positioned apart from the working plane 4 according to sensed optical signals. The microprocessor 51 retrieves data of the motion of the mouse from the optical displacement sensor 52, and thus clears the data. Meanwhile, the microprocessor 51 outputs information to the computer to inform that the mouse is apart from the working plane. In such a way, when the user lifts the mouse up from the working plane, the displacement signal outputted from the optical displacement sensor 52 won't cause the cursor shake.

It should be noted that whether the light path is cut off or not can be determined in accordance with the setting of the detecting area of the light sensing unit 32 on which the light is sensed. The present invention does not restrict a complete cutting off of the light path as said cutting off hereby, and does not restrict a complete unblocked light path as a not cutting off status.

In further considering to distinguish being turned over from being lifted up, the mouse can be further modified to set that when the mouse is positioned on the working plane 4 the column shaped member 2 cuts off a half of the detecting area of the light sensing unit 32, and when the mouse is lifted up or turned over, the column shaped member 2 completely cuts off or completely not cuts off the detecting area of the light sensing unit 32.

According to an aspect of the current embodiment, the light sensing unit of the current embodiment can be a dual phototransistor (having two sensing units). The two sensing units are arranged in a direction perpendicular to the working plane 4. When the mouse is positioned on the working plane 4, a lower one of the two sensing units is cut off from receiving the light projected from the light emitting unit 31. When the mouse is lifted up from the working plane or turned over, the column shaped member 2 cuts off both or none of the two sensing units, respectively. Of course, the current embodiment can be further modified for identifying a first height and a second height that the mouse apart from the working plane. The principle is similar to that of the first embodiment, and is not to be iterated hereby.

### The Third Embodiment

The third embodiment is to utilize the reflectivity characteristics of the light emitting unit and the light sensing unit regarding the working plane. Referring to FIG. 6, it is a structural diagram illustrating a mouse positioned on a working plane 4. As shown in FIG. 6, the light emitting unit 31, the light sensing unit 32 and a light isolation plate 33 are positioned at where a bottom cover of the mouse contacts the working plane 4, or where pads under the bottom cover of the mouse contact the working plane. The light emitting unit 31 and the light sensing unit 32 each is configured with a hole at the light path therebetween so as to allow the light passing therethrough. The light isolation plate 33 is positioned between the light emitting unit 31 and the light sensing unit 32. The light isolation plate 33 can be configured integrally with the bottom cover 1 or as an independent element. In other embodiments, it is also applicable that only one of the light emitting unit 31 and the light sensing unit 32 is positioned at where the pads under the bottom cover 1 of the mouse contacts the working plane 4. Alternatively a module including the light emitting unit 31, the light sensing unit 32, and the light isolation plate 33 can be employed. In the current embodiment, the light sensing unit 32 is preferred to be disposed at the foot pads of the bottom cover 1 of the mouse.

When the mouse is positioned on the working plane 4, the light isolation plate 33 blocks the light emitted from the light emitting unit 31, and therefore the light sensing unit 32 fails to sense a reflected light. As such, it can be learnt that the mouse is positioned on the working plane 4.

Referring to FIG. 6A, when the mouse is lifted up from the working plane, the light emitting unit 31 projects a light onto the surface of the working plane 4. The light is then reflected to the light sensing unit 32. The microprocessor 51 then determines that the mouse is positioned apart from the working plane 4 according to the sensed optical signals. After retrieving the motion data of the mouse from the optical displacement sensor 52, the microprocessor 51 clears the motion data of the mouse. Meanwhile, the microprocessor 51 outputs information to the computer to inform that the mouse is apart from the working plane. In such a way, when the user lifts the mouse up from the working plane 4, the displacement signal outputted from the optical displacement sensor 52 won't cause the cursor shake.

Correspondingly, as shown in FIG. 7, a further modified application of the third employment according to the present invention employing two light sensing units (i.e., also known as a dual phototransistor receiver often used in optical mice or ball mice) is shown. Referring to FIG. 7, the dual phototransistor receiver including two light sensing units 32A and 32B. The two light sensing units 32A and 32B are arranged substantially in a line with the light emitting unit 31 when observed in a top view. A second light isolation plate is positioned between the two light sensing units 32A and 32B. The two light sensing units 32A and 32B can be disposed in a plane parallel with the working plane (as shown in FIG. 7), or alternatively unparallel with the working plane (as shown in FIG. 7A). In other words, the two light sensing units 32A and 32B may be distant to the plane defined by the foot pads for a same distance or different distances. Further, the microprocessor 51 determines that the height of the mouse relative to the working plane 4 and the direction that the mouse moves relative to the working plane 4 according to the sensed optical signals. In other words, the microprocessor 51 can identify the difference between lifting the mouse to a first height and to a second height. Even though it is incapable of identifying the turnover of the mouse, the turnover of the mouse can be categorized as lifting the mouse up to the second height or above, thus turning off the power supply of the displacement sensing light emitting unit 53.

### The Fourth Embodiment

The fourth embodiment is also to utilize the reflectivity characteristics of the light emitting unit and the light sensing unit regarding the working plane. Referring to FIG. 8, the mouse includes a light emitting unit 31, two light sensing units 32A and 32B, and a light isolation plate 33. The first light sensing unit 32A is positioned at where the bottom cover 11 of the mouse contacts the working plane 4, or where the pads 12 under the bottom cover 11 of the mouse contact the working plane 4. The light emitting unit 31 and the second light sensing unit 32B are positioned under the mouse and are not in contact with the working plane 4. The two light sensing units 32A, 32B, and the light emitting unit 31 each is configured with a hole at the light path therebetween so as to allow the light passing therethrough. The opaque light isolation plate 33 is positioned between the light emitting unit 31 and the light sensing units 32A and 32B. When the mouse is positioned on the working plane 4, the light isolation plate 33 blocks the light path of the light emitted from the light emitting unit 31 to the first light sensing unit 32A, and therefore the first light sensing unit 32A fails to sense a reflected light. However, the light projected from the light emitting unit 31 onto the working plane 4 can be reflected or scattered to the second light sensing unit 32B. As such, the microprocessor 51 determines that the mouse is in positioned on the working plane 4 according to the sensed optical signals by the second light sensing unit 32B.

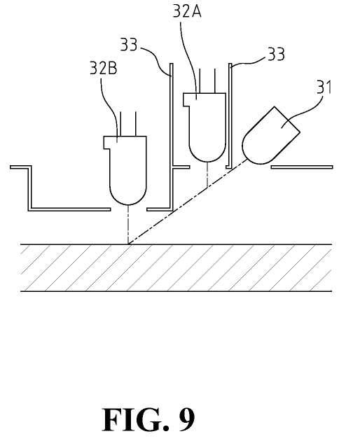

Referring to FIG. 9, when the mouse is apart from the working plane 4 for a short distance, the light emitting unit 31 projects the light onto the working plane 4, so that the light can be reflected or scattered to both the first light sensing unit 32A and the second light sensing unit 32B. In this case, the microprocessor 51 determines that the mouse is apart from the working plane 4 for a short distance. Meanwhile, the microprocessor 51 clears the motion data of the mouse, and outputs information to the computer to inform that the mouse is apart from the working plane 4 for a short distance. In such a way, when the user lifts the mouse up from the working plane, the displacement signal outputted from the optical displacement sensor 53 won't cause the cursor shake.

Referring to FIG. 10, the mouse is lifted up from the working plane 4 for a long distance, and therefore there is substantially no light projected from the light emitting unit 31 onto the working plane 4. Both of the first light sensing unit 32A and the second light sensing unit 32B correspondingly fail to sense any reflected light or scattered light from the working plane 4. Accordingly, the microprocessor 51 determines that the mouse is lifted up from the working plane 4 for a long distance according to the sensed optical signals.

It should be further clarified that the light emitting unit 31, the light sensing unit 32 and the light isolation plate 33 can be alternatively integrally configured as a module in accordance with the spirit of the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A mouse having a shake-elimination function when leaving a working plane, comprising:
an optical displacement sensor, and a displacement sensing light emitting unit, wherein the optical displacement sensor and the displacement sensing light emitting unit are adapted for detecting a displacement amount of a movement of the mouse on a working plane and outputting the displacement amount via a communication interface of the optical displacement sensor;
a microprocessor;
a light emitting unit;
a light sensing unit;
a column shaped member; and
a bottom cover disposed at of a body of the mouse,
wherein the bottom cover is configured with an opening, and when the mouse is positioned on the working plane, the column shaped member gets in contact with the working plane and is moved vertically upward, and when the mouse is lifted up apart from the working plane, the column shaped member vertically falls downward; and
wherein the light emitting unit and the light sensing unit are adapted for sensing the upward and the downward motions of the column shaped member thus generating a sensed optical signal, and the microprocessor is adapted for determining whether the mouse is positioned apart from the working plane according to the sensed optical signal, and when it is determined that the mouse is positioned apart from the working plane, the microprocessor clears the displacement amount obtained from the communication interface of the optical displacement sensor.

2. The mouse according to claim 1, wherein the light emitting unit and the light sensing unit sense the upward and the downward motions of the column shaped member in a manner that the light sensing unit senses a reflected light of a light projected by the light emitting unit onto the column shaped member.

3. The mouse according to claim 1, wherein the light emitting unit and the light sensing unit sense the upward and the downward motions of the column shaped member in a manner that the column shaped member cuts off a light path of a light directly projected by the light emitting unit to the light sensing unit.

4. The mouse according to claim 1, wherein the light sensing unit is a dual phototransistor receiver constituted by two light sensing sub-units.

5. The mouse according to claim 1, wherein when the mouse is turned over upside down, the mouse is identified as being apart from the working plane.

6. The mouse according to claim 1, wherein the microprocessor retrieves the sensed optical signal from the light sensing unit, and determines a direction that the mouse moves relative to the working plane according to the sensed optical signal.

7. The mouse according to claim 1, wherein when the mouse is positioned on the working plane, the bottom cover of the mouse comprises foot pads in contact with the working plane.

8. The mouse according to claim 1 further comprising a switching circuit serially coupled to a power supply and the displacement sensing light emitting unit, wherein when the mouse is lifted up apart from the working plane, the switching circuit turns off the power supply of the displacement sensing light emitting unit.

9. The mouse according to claim 1, further comprising a switching circuit serially coupled to a power supply and the displacement sensing light emitting unit, wherein the microprocessor retrieves the sensed optical signal and determines whether the mouse is lifted up apart from the working plane according to the sensed optical signal so as to control the switching circuit to turn off the power supply of the displacement sensing light emitting unit.

10. The mouse according to claim 1, wherein the column shaped member is provided with a spring member at a surface of an upper side or a protrusion portion of the column shaped member.

11. A mouse having a shake-elimination function when leaving a working plane, comprising:
an optical displacement sensor, and a displacement sensing light emitting unit, wherein the optical displacement sensor and the displacement sensing light emitting unit are adapted for detecting a displacement amount of a movement of the mouse on a working plane and outputting the displacement amount via a communication interface of the optical displacement sensor;
a microprocessor;
a light emitting unit;
a light sensing unit; and
a bottom cover of a body of the mouse,
wherein the bottom cover of the body of the mouse is configured with two openings, and when the mouse is positioned on the working plane, a side surface of one of the two openings is in contact with the working plane; and light paths of the light emitting unit and the light sensing unit pass through the two openings respectively,
wherein when the mouse is positioned on the working plane, the light sensing unit fails to sense the light emitted from the light emitting unit, and when the mouse is apart from the working plane, the light emitted from the light emitting unit can be reflected by the working plane to the light sensing unit; and
the microprocessor obtains a sensed optical signal and determines whether the mouse is positioned apart from the working plane according to the sensed optical signal, and when it is determined that the mouse is positioned apart from the working plane, the microprocessor clears the displacement amount obtained from the communication interface of the optical displacement sensor.

12. The mouse according to claim 11, wherein an light isolation plate is disposed between the light emitting unit and the light sensing unit for isolating stray lights from the light path of from the light emitting unit to the light sensing unit.

13. The mouse according to claim 11, wherein the microprocessor retrieves the sensed optical signal from the light sensing unit, and determines a direction that the mouse moves relative to the working plane according to the sensed optical signal.

14. The mouse according to claim 11, wherein when the mouse is positioned on the working plane, the side surface of the opening of the bottom cover of the mouse comprises foot pads in contact with the working plane.

15. The mouse according to claim 11 further comprising a switching circuit serially coupled to a power supply and the displacement sensing light emitting unit, wherein when the mouse is lifted up apart from the working plane, the switching circuit turns off the power supply of the displacement sensing light emitting unit.

16. The mouse according to claim 11, further comprising a switching circuit serially coupled to a power supply and the displacement sensing light emitting unit, wherein the microprocessor retrieves the sensed optical signal and determines whether the mouse is lifted up apart from the working plane according to the sensed optical signal so as to control the switching circuit to turn off the power supply of the displacement sensing light emitting unit.

17. A mouse having a shake-elimination function when leaving a working plane, comprising:
an optical displacement sensor, and a displacement sensing light emitting unit, wherein the optical displacement sensor and the displacement sensing light emitting unit are adapted for detecting a displacement amount of a movement of the mouse on a working plane and outputting the displacement amount via a communication interface of the optical displacement sensor;
a microprocessor;
a light emitting unit;
a first light sensing unit and a second light sensing unit; and
a bottom cover of a body of the mouse,
wherein the bottom cover of the body of the mouse is configured with three openings, and when the mouse is positioned on the working plane, a side surface of one of the three openings is in contact with the working plane and side surfaces of the other two openings are not in contact with the working plane; light paths of the light emitting unit, the first light sensing unit and the second light sensing unit pass through the two openings respectively; and the first light sensing unit is disposed at the opening which side surface is in contact with the working plane, and a light emitted from the light emitting unit can be reflected to the first light sensing unit and the second light sensing unit,
wherein when the mouse is positioned on the working plane, the first light sensing unit fails to sense the light emitted from the light emitting unit, while the second light sensing unit can sense the light emitted from the light emitting unit, and when the mouse is apart from the working plane for a short distance, the light emitted from the light emitting unit can be reflected by the working plane to both of the first light sensing unit and the second light sensing unit, and when the mouse is apart from the working plane for a long distance, both of the first light sensing unit and the second light sensing unit fail to sense the light emitted from the light emitting unit; and
the microprocessor obtains a sensed optical signal and determines whether the mouse is positioned apart from the working plane according to the sensed optical signal, and when it is determined that the mouse is positioned apart from the working plane, the microprocessor clears the displacement amount obtained from the communication interface of the optical displacement sensor.

18. The mouse according to claim 17, wherein the microprocessor retrieves the sensed optical signal from the light sensing unit, and determines a direction that the mouse moves relative to the working plane according to the sensed optical signal.

19. The mouse according to claim 17, wherein light isolation plates are disposed between the light emitting unit and the light sensing units for isolating stray lights from the light path of from the light emitting unit to the light sensing units.

20. The mouse according to claim 17, wherein when the mouse is positioned on the working plane, the side surface of the opening of the bottom cover of the mouse comprises foot pads in contact with the working plane.

21. The mouse according to claim 17 further comprising a switching circuit serially coupled to a power supply and the displacement sensing light emitting unit, wherein when the mouse is lifted up apart from the working plane, the switching circuit turns off the power supply of the displacement sensing light emitting unit.

22. The mouse according to claim 17, further comprising a switching circuit serially coupled to a power supply and the displacement sensing light emitting unit, wherein the microprocessor retrieves the sensed optical signal and determines whether the mouse is lifted up apart from the working plane according to the sensed optical signal so as to control the switching circuit to turn off the power supply of the displacement sensing light emitting unit.

23. The mouse according to claim 17, wherein the light emitting unit, the first light sensing unit, the second light sensing unit, and the light isolation plate are integrally formed as a module.

24. A mouse having a shake-elimination function when leaving a working plane, comprising:
an optical displacement sensor, and a displacement sensing light emitting unit, wherein the optical displacement sensor and the displacement sensing light emitting unit are adapted for detecting a displacement amount of a movement of the mouse on a working plane and outputting the displacement amount via a communication interface of the optical displacement sensor;
a microprocessor;
a light emitting unit;
a light sensing unit; and
a switch circuit serially coupled to a power supply and the displacement sensing light emitting unit,
wherein the light emitting unit and the light sensing unit are adapted for sensing whether the mouse is apart from the working plane and generating a corresponding sensed optical signal, and the switching circuit is adapted for turning on or turning off the power supply of the displacement sensing light emitting unit according to the sensed optical signal when it is sensed that the mouse is apart from the working plane.

25. The mouse according to claim 24, wherein a bottom cover of a body of the mouse is configured with an opening, and the mouse further comprises a column shaped member movable through the opening, wherein when the mouse is positioned on the working plane, the column shaped member gets in contact with the working plane and is moved vertically upward, and when the mouse is lifted up apart from the working plane, the column shaped member vertically falls downward, and the light emitting unit and the light sensing unit determines whether the mouse is apart from the working plane according to the upward and the downward motions of the column shaped member.

26. The mouse according to claim 25, wherein the light emitting unit and the light sensing unit sense the upward and the downward motions of the column shaped member in a manner that the light sensing unit senses a reflected light of a light projected by the light emitting unit onto the column shaped member.

27. The mouse according to claim 25, wherein the light emitting unit and the light sensing unit sense the upward and the downward motions of the column shaped member in a manner that the column shaped member cuts off a light path of a light directly projected by the light emitting unit to the light sensing unit.

28. The mouse according to claim 25, wherein the light sensing unit is a dual phototransistor receiver constituted by two light sensing sub-units.

29. The mouse according to claim 24, wherein the bottom cover of the body of the mouse is configured with a hole, and the light emitting unit and the light sensing unit are disposed in the hole.

30. The mouse according to claim 24, wherein the bottom cover of the body of the mouse is configured with two holes, and the light emitting unit and the light sensing unit are disposed in the two holes, respectively.
